(19) United States
(12) Patent Application Publication
(10) Pub. No.: US 2023/0070084 A1
(43) Pub. Date: Mar. 9, 2023

(54) METHOD FOR PRODUCING A WINDING HEAD SUPPORT, AND WINDING HEAD SUPPORT

(71) Applicant: ANDRITZ HYDRO GmbH, Wien (AT)

(72) Inventors: Fritz NEUMAYER, Graz (AT); Oliver JANTSCHNER, Graz (AT)

(73) Assignee: ANDRITZ HYDRO GmbH, Wien (AT)

(21) Appl. No.: 17/796,759

(22) PCT Filed: Dec. 3, 2020
(86) PCT No.: PCT/AT2020/060430

§ 371 Date: Aug. 1, 2022

(30) Foreign Application Priority Data
Feb. 21, 2020 (AT) A50130/2020

(51) Int. Cl. B23K 9/04; H02K 3/51

(52) U.S. Cl. CPC B23K 9/044; H02K 3/51

(57) ABSTRACT

A method for producing a winding head support for a rotor of a rotating electric machine. To enable the production of even particularly large winding head supports in a simultaneously simple manner, it is provided that the winding head support is formed using an additive manufacturing process, in particular by wire arc buildup welding. Embodiments also relate to a winding head support.

The invention relates to a method for producing a winding head support for a rotor of a rotating electric machine.

The invention further relates to a winding head support for a rotor of an electric machine.

Winding head supports for rotors of electric machines and methods for producing the same are known from the prior art. Winding head supports of this type are provided in order to absorb the centrifugal forces acting on a winding head of the rotor as a result of a rotation, so that impermissible deformations of the winding head are avoided. Winding head supports from the prior art are normally formed by a high-strength material, preferably by a high-strength, non-magnetizable steel, and often comprise, as described in the document AT 508 622 A1 for example, one or two rings, wherein corresponding rings are typically formed by forging and rolling, and possibly additional processes, to attain a particularly high strength.

However, winding head supports of this type can only be formed up to a maximum size predetermined by a given rolling apparatus. Furthermore, a maximum size of winding head supports of this type is also limited by a transport distance from a production facility to a location at which the electric machine is to be operated, typically a power plant. Up to now, it has thus only been possible to produce winding head supports up to a maximum inner diameter of up to approximately 6 m, whereby said winding head supports can also become a limiting factor in a machine design.

This is addressed by the invention. The object of the invention is to specify a method of the type named at the outset with which a winding head support can be produced independently of a limitation predetermined by a forging or rolling device.

Furthermore, a winding head support of this type shall be specified.

According to the invention, the first object is attained with a method of the type named at the outset in which the winding head support is formed by an additive manufacturing process, in particular by wire are buildup welding.

Over the course of the invention, it was found that correspondingly high strengths are surprisingly attainable even with an object produced in an additive manufacturing process.

Devices for forging and rolling are therefore no longer required in order to form a winding head support, whereby a production no longer necessarily needs to take place in a production plant with a forging or rolling device. A production of a corresponding winding head support is therefore also possible on-site, for example at a location where a power plant is being built.

In principle, widely different additive manufacturing processes can be used to form a corresponding winding head support, including for example welding processes involving the use of a laser, or submerged arc welding processes. It has proven particularly advantageous for attaining a high strength, however, if the winding head support is formed using wire arc buildup welding. A manufacturing process of this type is also referred to as wire arc additive manufacturing. Via the choice of a corresponding wire, it is thereby easily possible to influence a property of the winding head support. Typically, a wire is used with which, in a corresponding method, an austenitic structure can be attained in a formed weld or in the winding head support, in order to obtain a non-magnetizable winding head support with simultaneously high strength.

Although a winding head support of this type can, in principle, also be formed by individual segments that are detachably connected to one another, it is preferably provided that the winding head support is embodied to be ring-shaped. A corresponding winding head support thus preferably comprises one or more rings with which a winding head of a rotor can be stabilized.

A corresponding ring-shaped winding head support can, for example, be formed in a simple manner by multiple ring-shaped welds connected to one another and can subsequently be arranged externally or internally on the winding head in order to support the winding head against centrifugal forces.

In principle, the winding head support can be formed using any material with which the mechanical, thermal, and magnetic properties required for a particular machine can be achieved, that is, also using a plastic, ceramic, or the like. However, the required properties can be attained in a simple and simultaneously reliable manner if a fully austenitic structure is formed by the additive manufacturing process.

Even though the winding head support can in principle also be formed by a 3D printing or sintering process, wherein particles of metallic powder are connected to one another, for example, it is preferred for the purpose of attaining a particularly high strength that the winding head support is formed with a buildup welding of multiple layers of a metal, wherein the built-up layers preferably have a fully austenitic structure. In this case, the metal is preferably continuously fed to the weld as a wire. The winding head support, which is typically embodied as a ring or comprises one or more rings, is thus produced layer-by-layer by applying multiple welds arranged on top of one another, wherein the individual welds are typically embodied to be circular or ring-shaped. Due to the magnetic properties, a fully austenitic structure of the formed rings or the formed winding head support is especially beneficial for use in an electric machine.

A particularly simple production method is achieved if the winding head support is formed with an application of a material to a carrier element that moves, in particular rotates about a rotation axis. For example, a ring with a very large diameter can then also easily be formed even if a welding device with which the winding head support is formed by wire arc buildup welding is only slightly moved in order to apply welding deposit to different radial and axial positions of the ring. A movement of the welding device over a circumference of the ring is thus not necessary if the carrier element, which can be arranged on a rotating platform for example, is moved accordingly. The apparatus for producing a corresponding winding head support can thus be embodied to be very simple and cost-efficient. In addition, the production of a ring, or of a ring-shaped winding head support, with high precision is thus possible.

The carrier element can, in principle, be formed from the same material as the winding head support. However, it can also be provided that the carrier element is formed from a different material, for example a material with a lower strength than the winding head support. In this case, for the purpose of obtaining a homogeneous winding head support, it can be provided that the winding head support is detached from the carrier element after the formation of at least one layer of the winding head support, in particular after completion of the winding head support. The winding head support formed in this manner is thus connected to the carrier element, which is preferably composed of a metal, in a materially bonded manner. Therefore, in order to detach the winding head support from the carrier element, the winding head support can be cut off of the carrier element, for example.

A winding head support with high strength is obtained if the winding head support is formed in that multiple layers are arranged on top of one another, which layers are connected in a materially bonded manner. This can occur in a simple manner through an application of multiple welds on top of one another, wherein the individual welds are preferably formed from the same material. A layer can thus comprise one weld or multiple welds arranged next to and/or on top of one another. Preferably, a layer extends over an entire cross section of the winding head support being fabricated, for example over an entire cross section of a ring, and has a height of less than 10 cm, in particular of less than 5 cm. This ensures a stable and layer-by-layer construction of the winding head support.

In this context, it is beneficial if a layer is formed in that an inner boundary and an outer boundary of the layer are first formed, whereupon a space between the inner boundary and the outer boundary is filled with material. An inner boundary can constitute an inner diameter of a ring which forms the winding head support and an outer boundary can constitute the outer diameter of said ring, even though a ring formed by corresponding buildup welding can, of course, still be worked prior to use in an electric machine, for example by lathing, milling, or grinding, in order to obtain a particularly round winding head support or a winding head support with a particularly small imbalance.

Forming an inner boundary and an outer boundary of the layers first has proven effective for achieving a beneficial temperature during a fabrication of the layers and, simultaneously, a high production speed of the winding head support. At the same time, by filling in a region between the inner boundary and the outer boundary, a material with high strength and homogeneity, and without weld defects such as pores and blowholes, is easily obtained.

Normally, after the inner boundary and the outer boundary are formed, the space between the inner boundary and the outer boundary is filled, starting from the outer boundary, with additional welds in order to obtain a continuous layer between the inner boundary and outer boundary. It can also be provided that, after the inner boundary and the outer boundary are formed, one or two welds are initially arranged adjacent to the inner boundary or the outer boundary, whereupon additional welds are arranged starting from the outer boundary or the inner boundary in order to till in a space between the inner boundary and the outer boundary. In this manner, it is achieved that a weld adjacent to which an additional weld is placed has already cooled at least slightly, in order to minimize a risk of cracks during the welding process. A layer can have, for example, a height of two to five, in particular three, welds arranged on top of one another.

To achieve a high homogeneity and strength of the winding head support, it is preferably provided that the winding head support is formed with the use of a shielding gas in order to prevent oxide layers in the winding head support.

Beneficial mechanical and magnetic properties of the winding head support can easily be obtained if the winding head support is formed using a steel which has a chromium equivalent of 6% to 32%, preferably 10% to 28%, in particular 18% to 24%.

The chromium equivalent is calculated as follows:

Chromium equivalent=% Cr+% Mo+1.5% Si+0.5% Nb.

Furthermore, it has proven beneficial for achieving advantageous mechanical and magnetic properties if the winding head support is formed using a steel which has a nickel equivalent of 10% to 40%, preferably 16% to 32%, in particular 24% to 29%. The nickel equivalent of a steel is calculated as follows:

Nickel equivalent=% Ni+30% C+0.5% Mn

Alternatively or additionally, it can also be provided that an austenitic Mn steel or an austenitic Mn—N steel is used.

A corresponding steel is typically applied as a wire in the wire are buildup welding process in order to form the winding head.

Because steels of this type exhibit a high hot-cracking tendency, it is advisable to cool a layer, or a carrier element on which an additional layer or a weld is to be applied, before the new layer or the new weld is applied, preferably to a temperature of less than 1,250° C., particularly preferably less than 500° C., in particular less than 100° C. It is therefore beneficial if the production involves a cooling of an already-formed portion of the winding head support.

In principle, the cooling can occur in widely different ways. It is particularly efficient if the cooling takes place by applying a fluid, such as a gas or a liquid, in particular air, CO₂ or water, to an already-formed portion of the winding head support and/or a body thermally bonded to winding head support, in particular by means of a nozzle, wherein the fluid has a lower temperature than the formed portion of the winding head support. For example, a cold fluid can be directly applied to a formed portion of the winding head support, in particular a formed weld, in order to cool said portion.

Alternatively or additionally, it can also be provided for the purpose of cooling that the winding head support is arranged on a platform during production, wherein the platform is cooled, in particular using a fluid, preferably water. The platform, which can also be moved, in particular rotated, in order to form a ring-shaped winding head support in a simple manner for example, thus cools via conduction the winding head support that is arranged on the platform and connected thereto via surface contact. For this purpose, the platform can, for example, be arranged in a water bath or equipped with cooling lines through which water flows during operation in order to cool the platform. It is understood that, as an alternative or also in addition to a cooling of the winding head support, a cooling of the platform can occur via convection, in particular involving an application of a fluid to a portion of the formed winding head support.

To achieve particularly advantageous mechanical properties, it can be provided that, after the additive manufacturing process is carried out, a formed portion of the winding head support is heat-treated, wherein a heat treatment includes in particular a solution annealing, a quenching, and/or a stress relief annealing of the portion or of the entire winding head support. For example, a portion of the winding head support formed by an additive manufacturing process, in particular a formed ring, can be heat-treated in that the portion is solution-annealed and quenched in water, whereupon a stress relief annealing also possibly occurs, in order to achieve a beneficial corrosion resistance and to relieve internal stresses.

To obtain particularly precisely defined dimensions, it can be beneficial if, after the additive manufacturing process is carried out, a formed portion of the winding head support is subjected to a machining process, in particular a lathing, milling, and/or grinding. In this manner, a particularly low imbalance can also be achieved for a portion of a winding head support that is ring-shaped, for example.

If the winding head support or a portion of the same is subjected to a heat treatment as stated above, the heat treatment is typically carried out before the winding head support or a portion of the same is subjected to a machining process. Thus, as part of the machining, it also possible to even out dimensional changes that can occur due to thermal expansions in the course of the heat treatment, for example.

According to the invention, the other object is attained with a winding head support of the type named at the outset, wherein the winding head support is formed by an additive manufacturing process, in particular by a method according to the invention.

Typically, a corresponding winding head support is composed of an austenitic, preferably non-magnetizable material.

It is preferably provided that the winding head support is embodied as a ring or comprises one or more rings so that said rings can easily be attached to a winding head.

With a method according to the invention, winding head supports can in principle be designed in any desired size, so that they can also be used for generators of large hydroelectric power plants, for example. Typically, a winding head support of this type comprises a ring with an inner diameter of more than 1 m, preferably more than 4 m, in particular more than 6 m.

In an electric machine with a stator and a rotor, with the rotor comprising on one side at least one winding head, wherein a winding head support is provided in order to absorb centrifugal forces occurring during operation, it is beneficial that the winding head support is embodied according to the invention. As a result, large electric machines can also be realized with a winding head support in a relatively simple manner even outside of conventional production plants. An electric machine of this type can, for example, be designed as an asynchronous generator and be used in a hydroelectric power plant.

Preferably, a machine of this type comprises on each winding head an inner ring and an outer ring which have respectively been realized in a method according to the invention. It can thereby also be provided that the outer ring has been shrunk onto the winding head and forms a unit with the inner ring and winding bars of the machine in the region of the winding head according to the document AT 508 622 A1.

Additional features, advantages, and effects of the invention follow from the exemplary embodiments described below. In the drawings which are thereby referenced:

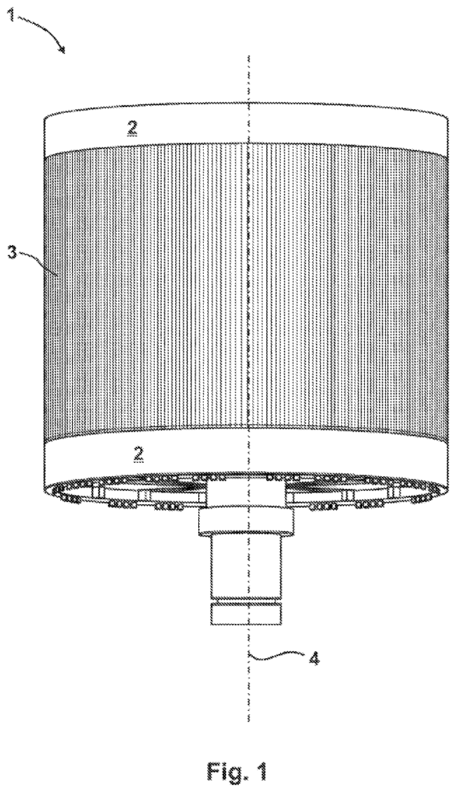

FIG. 1 shows an electric machine embodied as an asynchronous machine;

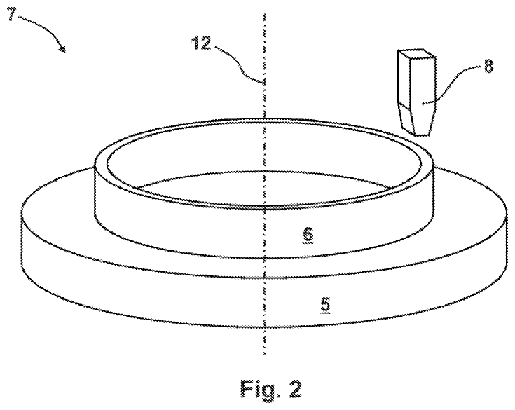

FIG. 2 shows an apparatus for producing a winding head support;

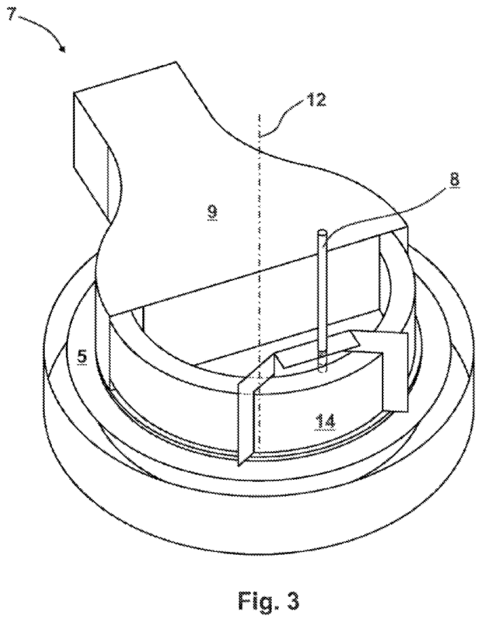

FIGS. 3 through 6 show additional apparatuses for producing a winding head support;

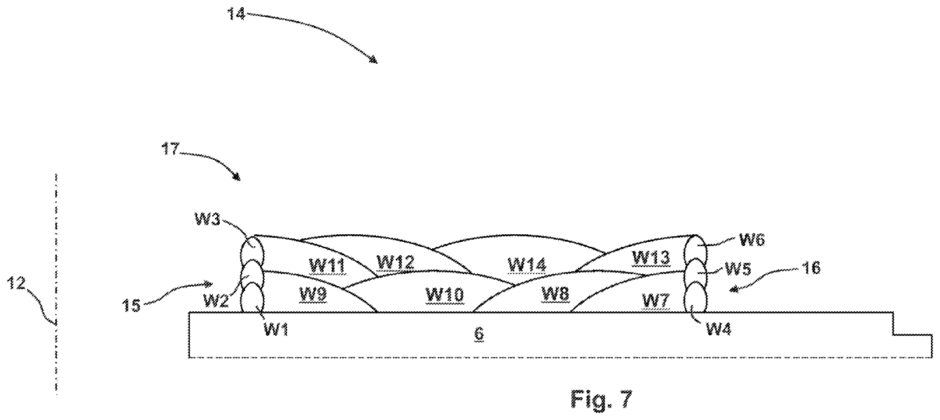

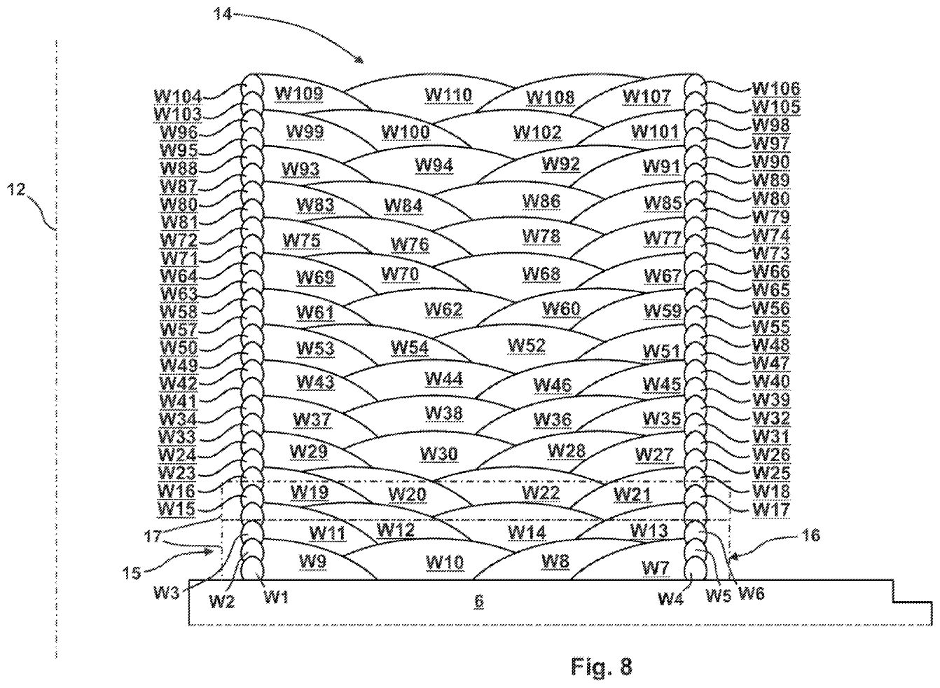

FIGS. 7 and 8 show cross-sectional illustrations of a detailed view of a winding head support.

FIG. 1 shows a rotor 1 of an electric machine embodied here as an asynchronous machine, which electric machine can be used as a motor or generator in a hydroelectric power plant. The rotor 1 comprises a rotor shaft and a rotor lamination stack 3 in which a rotor winding is arranged. The rotor winding protrudes out of the rotor lamination stack 3 at an end side, whereby winding heads are formed. In order to support the winding heads against centrifugal forces which occur during operation as a result of a rotation of the rotor about a rotor axis 4, winding head supports embodied to be ring-shaped are provided. The winding head supports can comprise an outer ring and an inner ring, wherein in FIG. 1 only the outer rings 2 are visible. A basic construction of a winding head support with an outer ring 2 and an inner ring is known from the document AT 508 622 A1, for example.

According to the invention, the winding head support, or the inner ring and/or the outer ring 2 of a corresponding winding head support, is no longer formed by forging, rolling, and possibly strain hardening, as is known from the prior art, but is rather produced using an additive manufacturing process.

FIG. 2 shows an apparatus 7 for carrying out a method according to the invention, wherein a ring-shaped winding head support is formed by wire arc buildup welding by means of a schematically illustrated welding device 8. The apparatus 7 comprises a platform S which can be rotated about a rotation axis 12 by means of a drive that is not illustrated, on which platform 5 a carrier element 6 is detachably arranged in order to form the ring-shaped winding head support, which can be used, for example, as an outer ring 2 of an electric machine illustrated in FIG. 1, on the carrier element 6 by applying multiple welds along a circumferential direction. The carrier element 6 can likewise have been produced in such a method, or can be composed of a different material that can merely be bonded to the welding deposit being applied. In the latter case, it can be provided that the carrier element 6 is separated from the winding head support after completion of the winding head support.

Because the platform 5 is rotated about the rotation axis 12, it is sufficient if the welding device 8 is only moved so far in an axial direction and in a radial direction relative to the rotation axis 12 as is necessary to form a radial and axial extension of the winding head support. Thus, due to the rotation of the platform 5 together with the carrier element 6 about the rotation axis 12, a movement of the welding device 8 in a circumferential direction about the rotation axis 12 is not necessary, which is why, with an apparatus 7 of this type, even rings 14 with a very large inner diameter of more than 6 m, for example, can easily be formed with only slight movements of the welding device 8. An apparatus 7 of this type is simply constructed and, in principle, can thus be set up even in a location at which the electric machine is to be used. As a result, the production of a winding head support on-site is also possible, whereby limitations on a maximum size of the winding head support caused by a transport distance are also no longer relevant.

Preferably, a steel having a chromium equivalent of 16% to 24% and a nickel equivalent of 22% to 29% is used as wire with which the winding head support is typically formed in a wire arc buildup welding process, in order to obtain a winding head support with an austenitic structure. Alternatively, a different austenitic steel, in particular an austenitic Mn steel or an austenitic Mn—N steel, can also be used. A steel of this type exhibits a high strength and, at the same time, magnetically beneficially properties for a winding head of an electric machine. Because a material of this type also exhibits a high hot-cracking tendency, it is preferably provided that the winding head support is cooled during the formation of the same.

For this purpose, a cooling can take place using a fluid, in particular air, CO₂, or water or steam, which fluid is applied to an already-formed portion of the winding head support or of a formed ring 14 of the winding head support in order to cool said portion by means of convection. To enable a dissipation of heat from the ring 14 in a simple manner, a housing 9 partially covering the ring 14 can be provided, as is illustrated in FIG. 3.

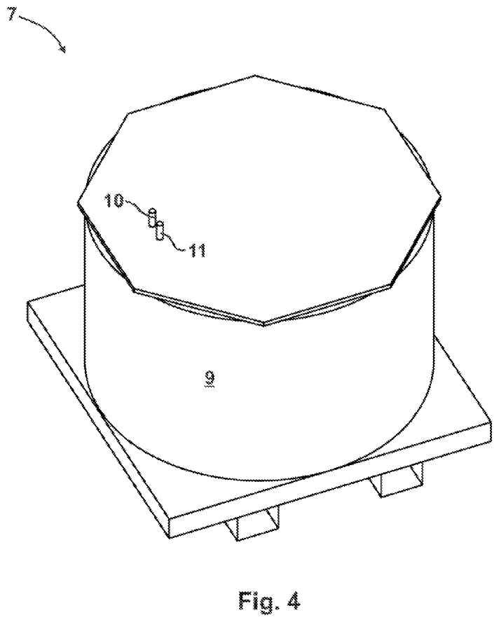

Furthermore, it can also be provided that a region in which the production of the ring 14 takes place is kept at constant low temperature by means of a heat exchanger. In this case, it is preferably provided that the production of the winding head support occurs in a closed housing 9. This is schematically illustrated in FIG. 4. As can be seen there, connections for the heat exchanger arranged within the ring protrude out of the housing 9, namely a flow 10 and a return 11 for a medium that is to be conveyed, for example water, through the heat exchanger, which is arranged in the housing and is not illustrated here.

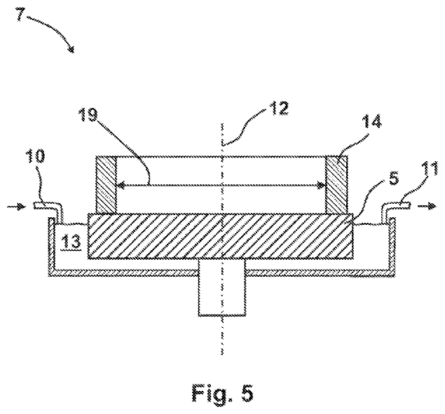

Alternatively or additionally, it can also be provided that the apparatus 7 with which production occurs is cooled. For example, the platform 5 on which the ring 14 is formed can be cooled using a liquid such as water, for example. This is illustrated by way of example in FIG. 5, wherein the platform 5 is surrounded by a water bath 13. Here, a flow 10 and a return 11 are also provided again, in order to be able to continuously supply the water bath 13 with cool water and conduct heated water out of the water bath 13.

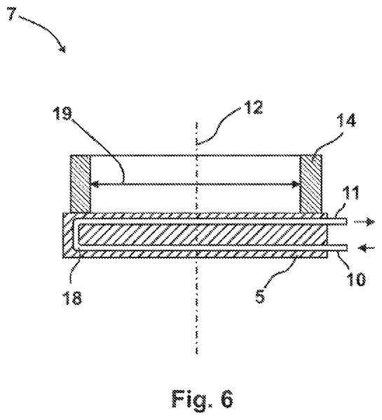

Of course, it is also possible that cooling lines 18 are provided in the platform 5 itself in order to cool the platform 5, and thus also the winding head support that is formed by way of example in this case by a ring 14 and is arranged on the platform 5. This is schematically illustrated in FIG. 6. Here, too, a flow 10 and a return 11 are provided in order to be able to ensure a flow through the cooling lines 18.

In FIG. 5 and FIG. 6, an inner diameter 19 of a correspondingly fabricated ring 14 of a winding head support is also visible, which inner diameter 19 can also easily be more than 6 m in a ring 14 produced according to the invention due to the independence of the production process from forging apparatuses or transport options.

FIG. 7 shows a detailed view of a section through a ring 14 of a winding head support for an asynchronous motor, which ring 14 is arranged on a carrier element 6 and embodied according to the invention, wherein welds W1, W2, W3, W4, W5, W6, W7, W8, W9, W10, W11, W12, W13, W14 of a layer 17 of the ring 14 are also illustrated. A winding head support embodied according to the invention typically comprises multiple layers 17, wherein in FIG. 7 only a bottommost layer 17 is illustrated, which layer 17 is arranged on a carrier element 6. Each layer 17 comprises an inner boundary 15 and an outer boundary 16, between which additional welds W7, W8, W9, W10, W11, W12. W13, W14 are arranged, and in this case extends over an entire cross-section of the ring 14 perpendicular to the rotation axis 12.

During production of the layer 17 of the ring 14 illustrated in FIG. 7, the three inner welds W1, W2, W3 are first formed, which constitute the inner boundary 15 of the bottommost layer 17, after which the three outer welds W4, W5, W6 are formed, which constitute the outer boundary 16 of the layer 17. It is understood that, during production of the ring 14 using an apparatus 7 according to FIG. 1, the outer boundary 16 has a greater distance from the rotation axis 12 than the inner boundary 15. Once the inner boundary 15 and the outer boundary 16 have been formed, a remaining space between the inner boundary 15 and the outer boundary 16 is then filled in with the bottommost welds W7, W8, W9, W10, wherein a lower outer weld W7 is first applied adjacent to the outer boundary 16, after which an additional lower weld W8 is applied adjacent to the lower outer weld W7, after which a lower inner weld W9 is applied adjacent to the inner boundary 16, after which a final lower weld W10 is applied between the lower inner weld W9 and the additional lower weld W8.

Upper welds W11, W12, W13, W14 are subsequently arranged on the lower welds W7, W8, W9, W10, wherein starting at the inner boundary 15 the upper inner weld W11 is first applied and then the additional upper inner weld W12, after which additional welds W13 and W14 are applied starting from the outer boundary 16, in order to till in a space between the outer boundary 16 and the inner boundary 15.

In a corresponding sequence, additional layers 17 are then formed on the bottommost layer 17 illustrated in FIG. 7. FIG. 8 shows a section through a ring 14 formed in this manner, wherein a sequence in which the individual welds W1 through W110 have been applied can be seen based on the ascending denotation of the individual welds W1 through W110.

Because of beneficial temperatures during production, a corresponding sequence leads to a particularly stable, non-porous, and blowhole-free construction of a corresponding ring 14, even though a different sequence in which the welds W1 through W110 are applied is, of course, also possible in principle.

To avoid oxide layers, which would be disadvantageous for a strength of the winding head support, the application of the welds typically takes place under a shielding gas.

With a winding head embodied according to the invention, generators and electric machines with a very large rotor diameter can also be formed independently of existing production capacities in terms of available forges and/or rolling mills, even outside of conventional production plants or on-site.

1. A method for producing a winding head support for a rotor of a rotating electric machine, wherein the winding head support comprises one or more rings with an inner diameter of more than 4 m and is formed using an additive manufacturing process, in particular by wire arc buildup welding, wherein the winding head support is formed with a buildup welding of multiple layers of a metal.

2. The method according to claim 1, wherein the winding head support comprises a ring.

3. The method according to claim 1, wherein an austenitic structure is formed by the additive manufacturing process.

4. (canceled)

5. The method according to claim 1, wherein the winding head support is formed with an application of a material to a carrier element that moves, in particular rotates about a rotation axis.

6. The method according to claim 1, wherein the winding head support is formed in that multiple layers are arranged on top of one another, which layers are connected in a materially bonded manner.

7. The method according to claim 6, wherein a layer is formed in that an inner boundary and an outer boundary of the layer are first formed, whereupon a space between the inner boundary and the outer boundary is filled with material.

8. The method according to claim 1, wherein the winding head support is formed with the use of a shielding gas in order to prevent oxide layers in the winding head support.

9. The method according to claim 1, wherein the winding head support is formed using a steel which has a chromium equivalent of 6% to 32%, preferably 10% to 28%, in particular 18% to 24%.

10. The method according to claim 1, wherein the winding head support is formed using a steel which has a nickel equivalent of 10% to 40%, preferably 16% to 32%, in particular 24% to 29%.

11. The method according to claim 1, wherein the production takes place with a cooling of an already-formed portion of the winding head support.

12. The method according to claim 11, wherein the cooling takes place by applying a fluid, in particular air, CO₂, or water, to an already-formed portion of the winding head support and/or a body thermally bonded to the winding head support, wherein the fluid has a lower temperature than the formed portion of the winding head support.

13. The method according to claim 11, wherein the winding head support is arranged on a platform during production, wherein the platform is cooled, in particular using a fluid, preferably water.

14. The method according to claim 1, wherein, after the additive manufacturing process is carried out, a formed portion of the winding head support is heat-treated, wherein a heat treatment includes in particular a solution annealing, a quenching, and/or a stress relief annealing.

15. The method according to claim 1, wherein, after the additive manufacturing process is carried out, a formed portion of the winding head support is subjected to a machining process.

16. A winding head support for a rotor of an electric machine, wherein the winding head support is formed by an additive manufacturing process according to claim 1 and comprises one or more rings with an inner diameter of more than 4 m.

17. (canceled)

18. The winding head support according to claim 16, wherein the at least one ring has an inner diameter of more than 6 m.

19. An electric machine with a stator and a rotor, with the rotor comprising on an end side at least one winding head, wherein a winding head support is provided in order to absorb centrifugal forces occurring during operation, wherein the winding head support is embodied according to claim 16.
